(19) United States
(12) Patent Application Publication
(10) Pub. No.: US 2003/0107866 A1
(43) Pub. Date: Jun. 12, 2003

(54) Electrostatic chuck of an ion implanter

(76) Inventors: Tae-Won Lee, Incheon (KR); Hyung-Sik Hong, Suwon (KR); Do-Sun Ha, Osan-shi (KR); Myung-Sik Yun, Suwon (KR); Gyeong-Su Keum, Suwon (KR)

Correspondence Address: VOLENTINE FRANCOS, P.L.L.C., Suite 150, 12200 Sunrise Valley Drive, Reston, VA, 20191, US

(21) Appl. No.: 10/290,258

(22) Filed: Nov. 8, 2002

(30) Foreign Application Priority Data
Dec. 10, 2001 (KR) 2001-77810

(51) Int. Cl. H01H 1/00; H02B 1/00

(52) U.S. Cl. 361/234

(57) ABSTRACT

An electrostatic chuck of an ion implanter includes a base, a platen mounted on the base, and a clamp mechanically fixing the platen on the base. The clamp has a fixing member latched to the platen and coupling bolts that fix the fixing member to the base.

### BACKGROUND OF THE INVENTION

1. Field of the Invention

The present invention relates to an electrostatic chuck of a semiconductor device fabricating apparatus. More particularly, the present invention relates to an electrostatic chuck of an ion implanter.

2. Description of the Related Art

In a typical ion implanting process, a wafer is tilted at an angle relative to the direction of the incoming ions so as to prevent the ions from being implanted between silicon lattices of the wafer, which would otherwise result in the ions being implanted to a greater than desired depth. An electrostatic chuck (ESC) is used to electrostatically hold a wafer at the desired angle relative to the direction of the incoming ions.

A conventional electrostatic chuck of an ion implanter is illustrated in FIG. 1 and FIG. 2.

With reference to FIG. 1 and FIG. 2, a conventional electrostatic chuck 100 includes a base 110, a platen 120 mounted on the base 110, and a resin adhesive layer 130 for fixing the platen 120 to the base 110.

The base 110 and the platen 120 are made of aluminum and ceramic, respectively. The platen 120 comprises a ceramic insulating layer 122 and a ceramic dielectric layer 124 formed thereon. A wafer is placed on the platen 120 and, in particular, on the ceramic dielectric layer 124. An electrode 126 coupled to a power supply unit 128 is formed between the ceramic insulating layer 122 and the ceramic dielectric layer 124. Thus, the ceramic dielectric layer 124 produces static electricity by means of the current from the electrode 126. A wafer is attracted to the ceramic dielectric layer 124 of the platen 120 by the static electricity.

The ion implanting process is performed at room temperature. Therefore, unlike an etching device, the platen 120 does not serve to supply heat for the processing of the wafer. That is, the electrostatic chuck 100 merely holds the wafer during the ion implanting process. Furthermore, the base 110 does not act as a cooler for cooling the platen 120. Accordingly, the resin adhesive layer 130 can be employed to hold the base 110 and the platen 120 together.

Specifically, the platen 120 is divided into six sections. Each of the six sections is held to the base 110 by the resin adhesive layer 130. Discrete portions of the resin adhesive layer 130 are formed in each of the six sections.

However, a member to which the electrostatic chuck 100 is fixed is moved up/down in order to enhance the efficiency of the ion implanting process. The resin adhesive layer 130 thus often becomes detached by the external shock (the up/down movement and vibration) that it experiences during long-term use of the ion implanter. Processing errors may occur if the resin adhesive layer 130 becomes detached. Furthermore, a significantly great amount of time is required to re-attach the platen 120 to the base 110. Still further, particles produced during the ion implanting process and adhering to the electrostatic chuck 100 cannot be completely removed from the chuck because it is difficult to separate/couple the platen 120 from/to the base 110.

### SUMMARY OF THE INVENTION

One object of the present invention is to provide an electrostatic chuck having a platen that will remain attached to a base during long-time use, i.e., even when subjected to mechanical shock and vibrations over long periods of time.

Another object of the present invention is to provide an electrostatic chuck having a platen that can be readily coupled to and uncoupled from a base.

To achieve these objects, the present invention provides an electrostatic chuck for holding a wafer while the wafer is processed, the electrostatic chuck comprising a base, a platen disposed on the base, and coupling means for mechanically fixing the platen to the base. The platen comprises a ceramic insulating layer, an electrode situated on the ceramic insulating layer, and a ceramic dielectric layer disposed on the electrode.

The coupling means is preferably a clamp. The clamp includes at least one fixing member extending over a peripheral edge of the platen, and coupling bolts fixing the fixing member to the base.

The platen is preferably divided into a plurality of sections. In this case, the fixing member may be a singular annular member that extends over the outer peripheral edge of each of the sections of the platen. The outer peripheral edges of each of the sections of the platen are stepped so as to collectively form a latch jaw. The fixing member of the clamp is latched to the latch jaw so as to collectively secure all of the sections of the platen to the base.

Alternatively, a plurality of discrete fixing members may extend over the outer peripheral edges of the sections of the platen so that each of the sections of the platen may be removed from the base independently of the other sections of the platen.

In yet another embodiment, the clamp has an annular first fixing member latched to the outer peripheral edges of the respective sections of the platen, a second fixing member latched to the radially extending side edges of the respective sections of the platen, and a plurality of coupling bolts for fixing the first and/or second fixing member to the base. The first and second fixing members are preferably unitary.

Still further, the electrostatic chuck may comprise aligning means for positioning the platen accurately on the base. The aligning means is a guide. Preferably, the aligning means includes one or more sets of guide members associated with each of the sections of the platen. Each set of guide members includes a key and a key way into which the key extends.

### BRIEF DESCRIPTION OF THE DRAWINGS

These and other objects, features and advantages of the present invention will become more apparent from the following detailed description of the preferred embodiments thereof made with reference to the attached drawings, of which:

FIG. 1 is a plan view of an electrostatic chuck according to the prior art;

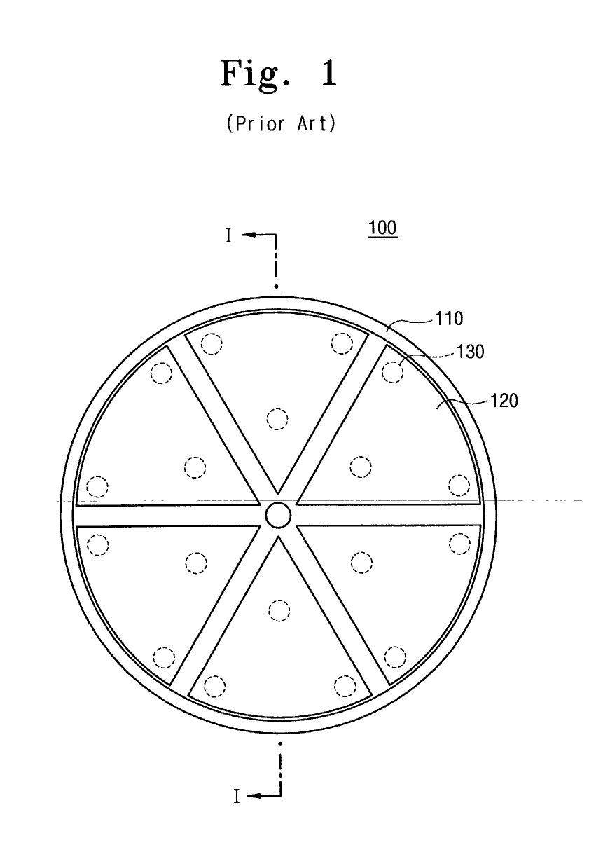

FIG. 2 is a cross-sectional view of the prior art electrostatic chuck as taken along line I-I of FIG. 1;

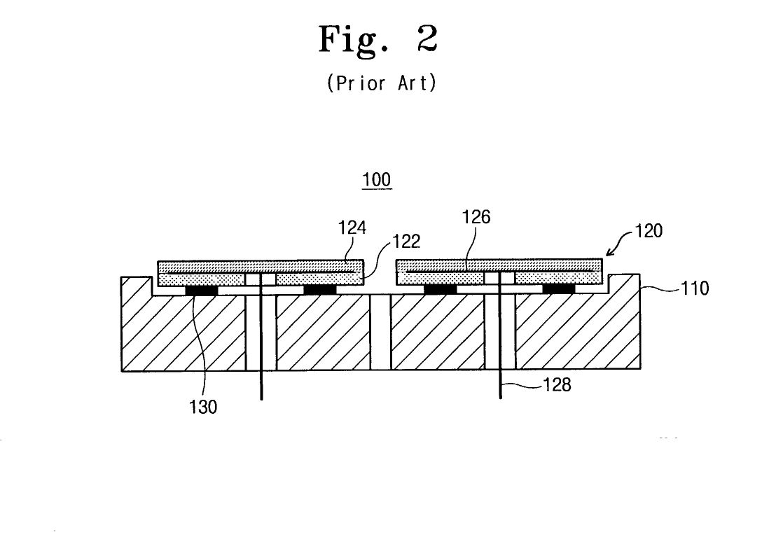

FIG. 3 is a plan view of a first embodiment of an electrostatic chuck according to the present invention;

FIG. 4 is a cross-sectional view of the electrostatic chuck according tot he present invention, as taken along line II-II of FIG. 3;

FIG. 5 is a top plan view of a second embodiment of an electrostatic chuck according to the present invention; and

FIG. 6 is a plan view of a third embodiment of an electrostatic chuck according to the present invention.

### DETAILED DESCRIPTION OF THE PREFERED EMBODIMENTS

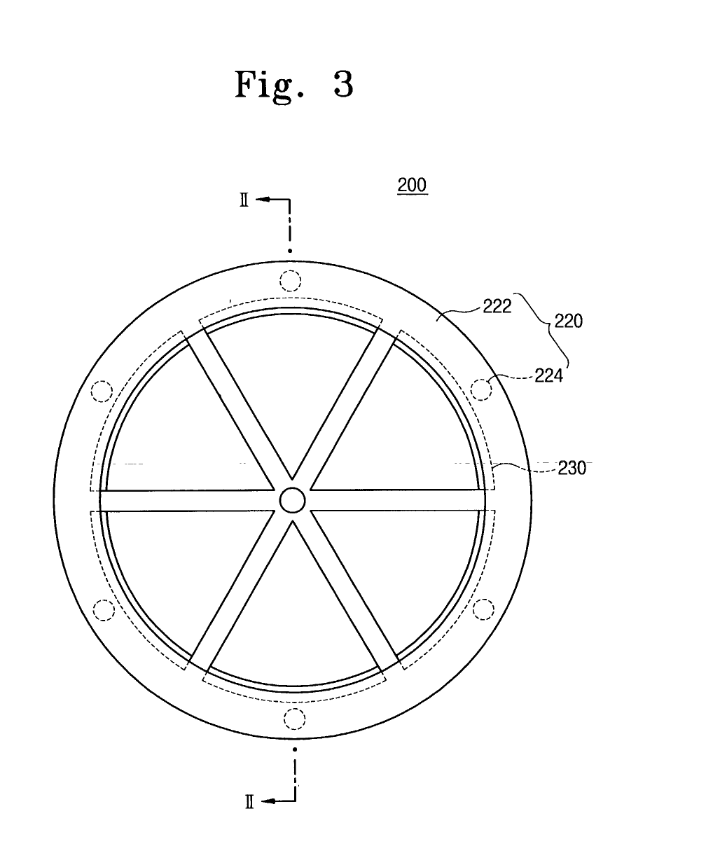

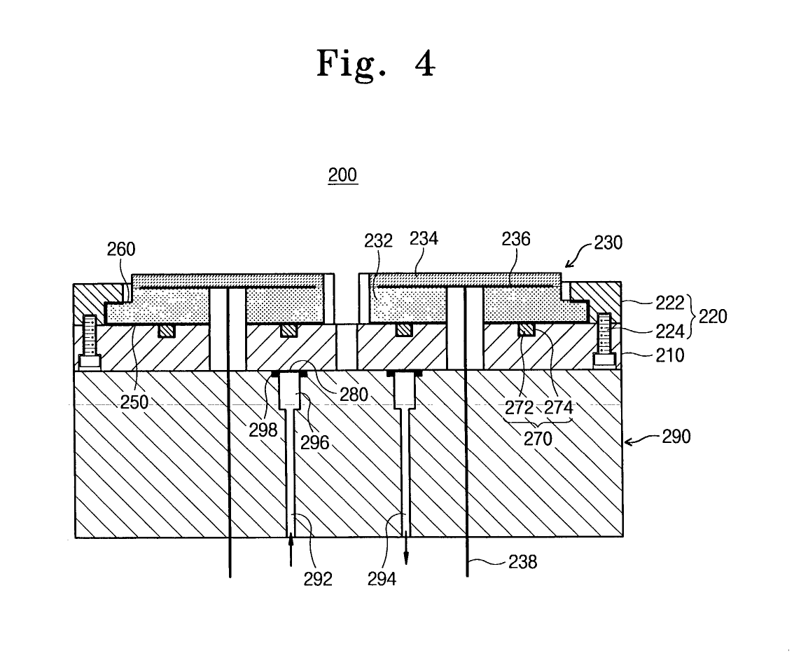

A first embodiment of an electrostatic chuck 200 of an ion implanter according to the present invention will now be described below with reference to FIG. 3 and FIG. 4.

The electrostatic chuck 200 includes a base 210, a platen 230, and coupling means 220. The platen 230 is comprised of six sections, and is fixed to the base 210 by the coupling means 220. The coupling means 220 is a clamp that includes an annular fixing member 222 extending over the edges of the six sections of the platen 230 en bloc, and coupling bolts 224 for fixing the fixing member 222 to the base 210. Thus, the edges of the platen 230, that are interposed between the fixing member 222 and the base 210, are clamped by the fixing member 222 to fix the platen 230 to the base 210. The coupling bolts 224 are disposed symmetrically about the center of the base 210.

More specifically, as shown in FIG. 4, the platen 230 has a latch jaw 260 defining a step in the outer peripheral edge of the platen and over which the fixing member 222 of the coupling means 220 is disposed. When the fixing member 222 and the base 210 are coupled by the coupling bolts 224, the latch jaw 260 is pressed against the base 210 by the fixing member 222, whereby the sections of the platen 230 are clamped to the base 210.

The platen 230 has a ceramic insulating layer 232 and a ceramic dielectric layer 234. An electrode 236 is interposed between the ceramic insulating layer 232 and the ceramic dielectric layer 234, and is coupled to a power supply line 238. An electrostatic force (static electricity) is created at the ceramic dielectric layer 234 by current supplied to the electrode 236 via the power supply line 238. A wafer is attracted to the ceramic dielectric layer 234 by the electrostatic force. Those sides of the base 210 and the fixing member 222 that contact the platen 230 are coated with a resin that forms an insulating layer 250. The insulating layer 250 serves to completely electrically insulate the platen 230 from the base 210, and to absorb shock caused by the rubbing of the platen 230 against the base 210 or the coupling of the platen 230 to the base 210.

The electrostatic chuck 200 also includes aligning means 270 that allows the platen 230 to be accurately positioned on the base 210. The aligning means 270 comprises one or more keys 272 and one or more key ways 274 into which the keys 272 are inserted, respectively. The keys 272 are formed at the platen 230, and the key ways 272 are formed at the base 210. Alternatively, the keys 272 and the key ways 274 may be formed at the base 210 and the platen 230, respectively. At least one key 272 and its associated keyway 274 are provided for each of the sections of the platen 230. Thus, the aligning means 270 allows all of the sections of the platen 230 to be accurately fixed to the base 210 by the coupling means 220.

The electrostatic chuck 200 is installed on a block 290 of a semiconductor fabricating apparatus. The block 290 defines a passageway through which cooling water flows. The passageway includes an inlet 292, an outlet 294, and a circular groove 296 formed in the upper surface of the block 290. The inlet 292 and the outlet 294 are connected to the circular groove 296. Accordingly, cooling water directed to the inlet 292 passes into the circular groove 296 to cool the electrostatic chuck 200. O-rings 298 are interposed between the upper surface of the block 290 and the electrostatic chuck 200 for preventing the cooling water from leaking out of the circular groove 296.

That surface of the base 210 which contacts the cooling water passing through the circular groove 296 is processed for preventing the base 210 from corroding. To this end, the surface is either anodized, coated with a metal that has good corrosion resistance, or is plasma coated.

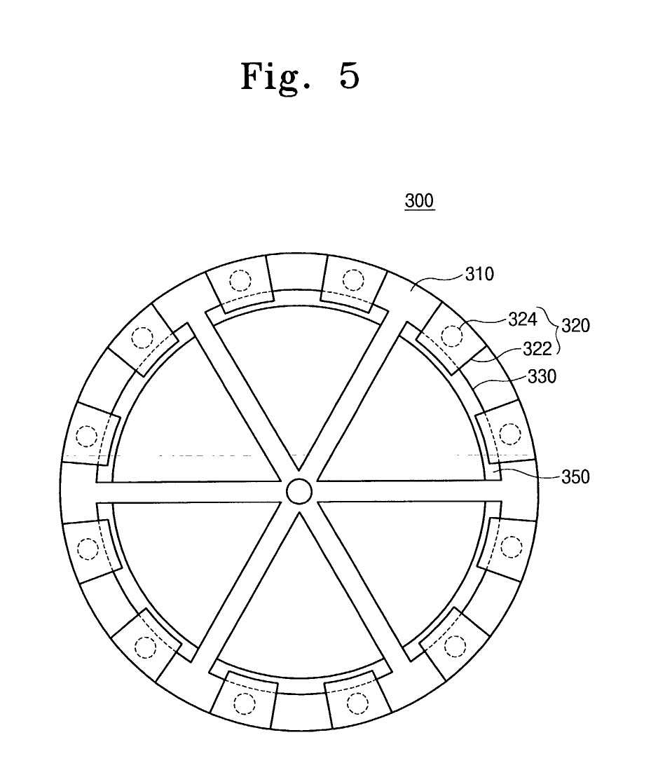

A second embodiment 300 of an electrostatic chuck according to the present invention will now be described with reference to FIG. 5. The electrostatic chuck 300 has a platen 330, and a coupling means 320 comprising one or more discrete fixing members 322 associated with each of the sections of the platen 330, instead of the single annular fixing member shown in FIG. 3. Each section of the platen 330 has a latch jaw 350 at the outer peripheral edge thereof, onto which a respective fixing member(s) 322 is/are latched. This makes it possible to individually replace the sections of the platen 330 and to remove particles from individual sections of the platen 330 if required. Furthermore, only defective portions of the platen 330 may be replaced without the need to remove other portions 330 of the platen. The remaining components of the electrostatic chuck 300 are similar to those of the embodiment of FIG. 4 and as such, will not be described in further detail.

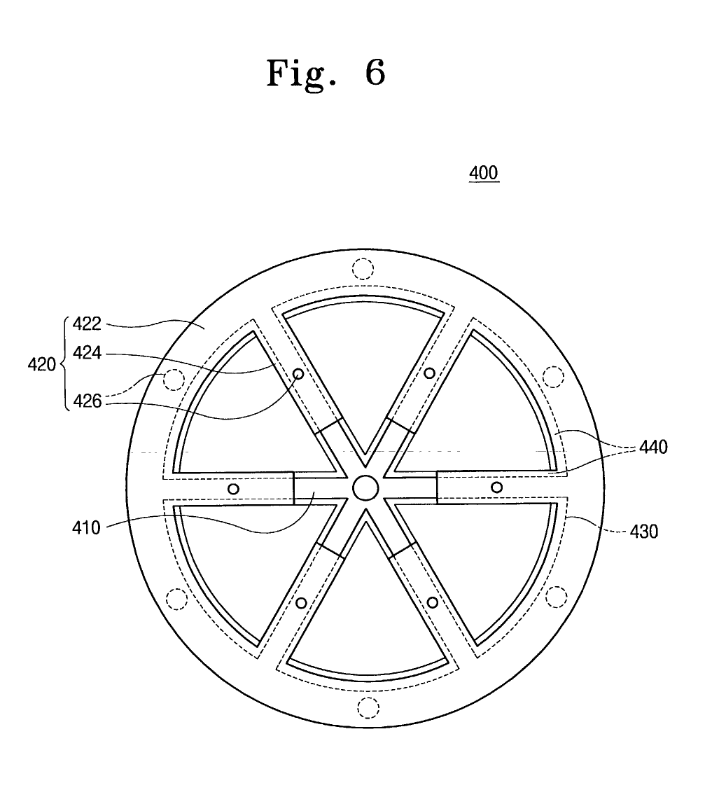

A third embodiment of an electrostatic chuck 400 according to the present invention will now be described with reference to FIG. 6. The electrostatic chuck 400 includes a base 410, a platen 430 having a plurality of discrete sections, and coupling means 420 for coupling the sections of the platen 430 to the base 410. The coupling means 420 has a ring-shaped first fixing member 422 extending over the outer peripheral edges of the sections of the platen 430, a second fixing member 424 extending over radially extending sides of the respective sections of the platen 422, and a plurality of coupling bolts 426 for fixing the first and second fixing members 422 and 424 to the base 410.

The first and second fixing members 422 and 424 are unitary. The outer peripheral edge and both sides of each respective section of the platen 430 form latch jaw 440 defining a step onto which the first fixing member 422 and the second fixing member 424 are latched, respectively.

The coupling bolts 426 may be provided only in connection with the first fixing member 422 or the second fixing member 424. Alternatively, the coupling bolts 426 may be provided in connection with the first and second fixing members 422 and 424 in order to provide a more stable coupling. The second fixing member 424 is shorter, in the radial direction, than the sides of the respective sections of the platen 430. The remaining components of the electrostatic chuck 400 of the embodiment of FIG. 6 are the same as those of the embodiment of FIG. 4 and as such, will not be described in detail.

In summary, the electrostatic chuck according to the present invention includes coupling means constituting a clamp for mechanically fixing a platen to a base such that the platen will not detach from the base due to external shock or heat. The coupling means also allows the platen to be easily separated from and coupled to the base. Accordingly, particles created during the processing of the wafer and adhering to the chuck can be readily removed from the chuck after the process is over. Furthermore, the time required for replacing the platen is relatively short.

Finally, although the present invention has been described above in connection with the preferred embodiments thereof, it should be understood that various changes, substitutions and alterations may be made thereto without departing from the spirit and scope of the invention as defined by the appended claims.

What is claimed is:

1. An electrostatic chuck for holding a wafer during a manufacturing process, comprising:
a base;
a platen dedicated to support a wafer while the wafer is being processed, the platen being disposed on said base; and
a clamp mechanically coupling the platen to the base.

2. The electrostatic chuck as claimed in claim 1, wherein the clamp includes a fixing member extending over an outer edge of the platen and coupling bolts fixing the fixing member to the base.

3. The electrostatic chuck as claimed in claim 1, wherein the platen comprises a plurality of discrete sections.

4. The electrostatic chuck as claimed in claim 2, wherein said outer edge of the platen is stepped so as to form a latch jaw over which said fixing member extends.

5. The electrostatic chuck as claimed in claim 4, wherein said platen comprises a plurality of discrete sections each having a radially outermost edge that is stepped such that said sections collectively form the latch jaw, and said fixing member of the clamp is annular and extends over said latch jaw.

6. The electrostatic chuck as claimed in claim 4, wherein said platen comprises a plurality of discrete sections, and said clamp includes at least one respective fixing member fixing each of said sections of the platen to the base.

7. The electrostatic chuck as claimed in claim 1, wherein said platen comprises a plurality of discrete sections, and the clamp includes a fixing member having an annular first portion latched to radially outer edges of the sections of said platen, and a second portion latched to side edges of the respective sections of said platen, and a plurality of coupling bolts fixing said fixing member to said base.

8. The electrostatic chuck as claimed in claim 7, wherein the outer edges and the side edges of each of the respective sections of said platen are stepped to form a latch jaw to which the first and second portions of the fixing member are latched.

9. The electrostatic chuck as claimed in claim 1, wherein the platen includes a ceramic insulating layer, an electrode disposed on the ceramic insulating layer, and a ceramic dielectric layer disposed on the electrode.

10. The electrostatic chuck as claimed in claim 1, wherein said platen has an electrically insulative layer extending thereover at locations where the platen contacts the base and the clamp.

11. The electrostatic chuck as claimed in claim 10, wherein the insulating layer comprises a resin.

12. The electrostatic chuck as claimed in claim 1, wherein the base is made of aluminum.

13. The electrostatic chuck as claimed in claim 1, and further comprising a guide that seats the platen in position on the base.

14. The electrostatic chuck as claimed in claim 13, wherein the platen comprises a plurality of discrete sections, and the guide includes a plurality of guide members that seat the sections of the platens on the base, respectively.

15. The electrostatic chuck as claimed in claim 13, wherein the guide includes at least one key, and at least one key way into which the at least one key extends, the at least one key being located adjacent one of said platen and said base, and the at least one key way being located in the other of said platen and said base.
